(19) United States
(12) Patent Application Publication
(10) Pub. No.: US 2010/0277772 A1
(43) Pub. Date: Nov. 4, 2010

(54) METHOD FOR MANAGING SETS OF DIGITALLY ACQUIRED IMAGES AND METHOD FOR SEPARATION AND IDENTIFICATION OF DIGITALLY ACQUIRED DOCUMENTS

(75) Inventors: Louis Destrée, Villers-la-Ville (BE); Michel Dauw, Machelen (BE); Pierre De Muelenaere, Court-Saint-Etienne (BE)

Correspondence Address: Jerold I. Schneider, 525 Okeechobee Blvd., Suite 1500, West Palm Beach, FL, 33401, US

(73) Assignee: I. R. I. S.

(21) Appl. No.: 12/673,531

(22) PCT Filed: Aug. 14, 2008
(86) PCT No.: PCT/EP08/60725

§ 371 Date: Feb. 15, 2010

Related U.S. Application Data
(60) Provisional application No. 60/956,071, filed on Aug. 15, 2007.

(51) Int. Cl. H04N 1/387; H04N 1/40

(52) U.S. Cl. 358/450; 358/448; 358/462

(57) ABSTRACT

Method for managing sets of digitally acquired images, the images of each set being acquired from the same original, comprising the steps of handling said sets of images as units and restricting use of predetermined operations to all images of one or more of said sets only. Further, a method for managing sets of digitally acquired images, the images of each set being acquired from the same original, each set comprising at least one front side image and at least one back side image, the method comprising the step of substantially simultaneously performing a first operation on the at least one front side image and a second operation on the at least one back side image, the second operation mirroring the first operation. Further, a method for separation and identification of digitally acquired documents, comprising the steps of: (i) calculating a signature for an incoming document on the basis its image, and (ii) correlating said signature with a database of signatures identifying document types.

### TECHNICAL FIELD

The present invention relates to a method for managing sets of digitally acquired images, such as for example used in scanning and indexing algorithms or software products. The present invention further relates to a method for separation and identification of digitally acquired documents.

### BACKGROUND ART

Some scanners on the market have the capability to scan in dual stream or in multi-stream. This means that the scanner generates more than one image for one side of paper sheet, e.g. for dual stream, one black and white and one color image is generated for one side of a paper sheet. Later on in the process, the color image will be used for instance for archiving purpose, while the black-and-white will be used for instance for document recognition purposes. Multi-stream scanning is also possible, for instance: one black and white, one grey scale and one color image is generated for one side of the paper sheet. So in general, multi-stream means that multiple images are generated during one scanning operation.

The existing software products on the market, are not well adapted to these multi-stream scanners. They are image based and have difficulties to handle multi-stream images, which often results in important risks of user mistakes. For instance, in an image based product, a user can inadvertently delete one of the three images relating to one side of a paper sheet. This will completely destroy the sequence of images and for example shift one image of the back side to the front side of the paper sheet. In an existing product with these limitations many features are not secure when scanning in dual stream such as for example image deletion, copy/paste or others, or do not even work at all in dual-stream, such as for example split/merge or others.

Scanning and indexing applications are for example known from WO 98/47098, from company ReadSoft, and all related patent publications mentioned in it (U.S. Pat. No. 4,933,979, U.S. Pat. No. 5,140,650 and U.S. Pat. No. 5,293,429).

Known scanning and indexing applications allow to separate documents automatically, thanks to the recognition of barcode, patch code and OCR zone on the leading page of each document. This recognition happens on-line (also called “real time” or “on the fly”, during the scanning, and at the speed of the scanner), or off-line (after the batch of documents has been scanned).

Some Scanning and indexing applications also allow to identify automatically a specific type of document, based on the recognition of a certain barcode, patch code, or OCR zone, one the leading page of each document, or on a subsequent page. This identification happens on-line (during the scanning) or off-line (after the batch of documents has been scanned). The type of the document is used to define the further processing that will be applied to the document (e.g. an invoice, a form of a certain type, a document to file, to transmit to a certain destination, etc. . . . )

The on-line document separation and identification of the document type in scanning and indexing systems are currently limited to barcode and patch code, and less frequently to the OCR of a small zone. For production scanners, only very fast technologies can be used to keep up with the speed of the scanner (up to 160 images per minutes, for instance). The speed of the scanner is for instance much higher than the speed of an OCR system that would process the entire page. This is why, the barcode recognition, patch code recognition and OCR is typically restricted to a small zone in the page.

Some products available on the market can identify documents by using templates. A template is a set of information to locate specific data on the document (piece of text, graphical elements like logos, lines, . . . ) The drawback of this method is that the template definition must be performed by skilled and trained people only. This takes time and effort. Furthermore, the templates must be adapted every time the document layout changes, and managing hundreds of templates becomes a nightmare.

In other products or patent publications, an identification method is based on the automatic detection of the lines present on the documents, with or without user intervention (U.S. Pat. No. 5,293,429 and WO 98/47098). This method automatically creates a “form map”, which is in fact a kind of template.

These methods are restricted to a limited class of documents containing lines (for example invoices and structured forms with frames or lines). Furthermore, in the method described in patent WO 98/47098, the user has to complete the form map by specifying a “recognition value” (RCG, which is portion of text specific to each document), and the location of this RCG, that will be recognized by OCR (like a bank giro number, an invoice number, etc.).

### DISCLOSURE OF THE INVENTION

It is a first aim of the present invention to provide a method for managing sets of digitally acquired images in which user mistakes can be avoided.

This first aim is achieved according to a first aspect of the invention with a method showing the steps of the first independent claim.

It is a second aim of the present invention to provide a method for managing sets of digitally acquired images in which certain user operations can be facilitated.

This second aim is achieved according to a second aspect of the invention with a method showing the steps of the second independent claim.

It is a third aim of the present invention to provide a method for document separation and identification with which the need for a specific code or zone on a page of the document can be avoided.

This third aim is achieved according to a third aspect of the invention with a method showing the technical steps of the third independent claim.

In a first aspect of the invention, a method is presented for managing sets of digitally acquired images, the images of each set being acquired from the same original. The method comprises the steps of handling said sets of images as units and restricting use of predetermined operations to all images of one or more of said sets only.

By preventing predetermined operations, i.e. operations which can be identified as disrupting the sequence of the images, and restricting their use in such a way that they can only be performed on a whole set (or multiple sets), user mistakes can effectively be avoided. In this way, for example a true dual- or multi-stream data structure can be achieved in which the images relating to the same page or the same side of a page or the same scanning operation are grouped and subsequently can be handled together. Operations which are restricted can for example be cropping, resizing, or other. By the restriction, the method is arranged for preventing a user from performing these operations on a single image of a set.

In preferred embodiments, the sets of images are organised according to a hierarchy comprising a document level, a set level and a single image level. A document is defined as a unit comprising a plurality of successive sets of images. A first series of operations is restricted to use on document level, a second series of operations, comprising the predetermined operations mentioned before, is restricted to use on set level and a third series of operations is restricted to use on image level. In this way, the data can be manipulated at these different levels while the risk of disruption of the data structure can be minimised.

In preferred embodiments, different modes are implemented to view and manipulate the information. One mode is implemented for each of said levels of said hierarchy.

In preferred embodiments, the method comprises the step of enabling a user to perform given image processing operations substantially simultaneously on all images of one or more of said sets. This can enhance user-friendliness of the method.

In preferred embodiments, each of said sets comprises at least one front side image representing a front side of said original and at least one back side image representing a back side of said original.

In preferred embodiments, each of said sets contains multi-stream images which are substantially simultaneously acquired from said same original. Preferably, security measures are implemented for avoiding operations that would distribute simultaneously acquired multi-stream images over different sets, for example a secure document split by which a document can only be split between two sets of images and a secure document merge by which documents can only be merged in such a way that the sets of images are maintained.

In preferred embodiments, the method further comprises the step of implementing filtering modes enabling a user to view only a same sub-set for each of said sets of images. This enables users to easily filter the different data and can present different views to the user according to his needs.

In a second aspect of the invention, which may or may not be combined with the other aspects of the invention, a method is presented for managing sets of digitally acquired images, the images of each set being acquired from the same original, each set comprising at least one front side image representing a front side of said original and at least one back side image representing a back side of said original, characterised in that the method comprises the step of substantially simultaneously performing a first operation on the at least one front side image and a second operation on the at least one back side image, the second operation mirroring the first operation.

Treating images jointly as front and back sides of the same original has the advantage that the number of operations a user has to perform to achieve a given desired result can be highly reduced.

In preferred embodiments, each of said sets contains at least two front side images and at least two back side images, said front and back side images respectively being multi-stream images which are substantially simultaneously acquired from said front side and said back side of said original.

A first example of mirrored operations is when the first and second operations are clockwise and counterclockwise rotations.

A second example of mirrored operations is when the first and second operations are cropping operations at opposite edges of said front and back side images.

A third example of mirrored operations is when the first and second operations are zooming operations on opposite zones of the front and back side images.

In a third aspect of the invention, which may or may not be combined with the other aspects of the invention, a method is presented for separation and identification of digitally acquired documents, comprising the step of providing a digitally acquired image of an incoming document. The identification comprises the steps of: (i) calculating a signature for said incoming document on the basis its image, and (ii) correlating said signature with a database of signatures identifying document types.

This identification by signature generation can avoid to perform OCR, allowing to reach a speed which is suitable for on-line separation and identification for even high-speed scanners. Since no OCR is necessary, the method can be language independent, can identify documents without any OCR content and can identify badly printed documents, like faxes.

Unlike barcode, patchcode and zoning OCR applications, this technique does not require any preparation of the documents before the scanning (for instance, stick a barcode on the first page of the document to ensure separation, or insert a separation sheet with an OCR zone or a patch code, before the beginning of a document, or defining regions of interest on the scanned images).

In preferred embodiments, said signature is calculated by applying a mathematical transformation on said image, preferably modeling based on a fast and robust image oriented algorithm.

In preferred embodiments, said signature is calculated on the basis of substantially the entire image.

In preferred embodiments, said signature is calculated on the basis of relevant (e.g. graphical) elements present in the image and their relative position on the page and their relative position. Preferably, said relevant elements comprise graphical elements such as one or more of the following: logos, lines of text, frames, lines, boxes.

In preferred embodiments, the method further comprises the steps of: (iii) if said correlation reveals no match with any of said signatures in said database, assigning a new document type to said signature, and (iv) adding said signature of said incoming document to said database.

In preferred embodiments, the method returns a number of matches with a confidence level for each match. Preferably in case only one match is returned, said match is accepted if the confidence level for the match is greater than a minimum value, given as a configuration parameter. Preferably in case at least two matches are returned, the match with the highest confidence level is accepted if the highest confidence level is above a minimum value, given as a first configuration parameter, and if the difference between the highest confidence level and the other confidence levels is greater than a minimum distance, given as a second configuration parameter.

In preferred embodiments, the method further comprises the steps of attaching the identified document type as an index to the image, said index defining a further processing to be performed on the image.

### BRIEF DESCRIPTION OF THE DRAWINGS

The invention will be further elucidated by means of the following description and the appended figures.

FIG. 1 shows a first screenshot of a running software product implementing the method according to the invention.

FIG. 2 shows a screenshot of a filtering operation being performed.

FIG. 3 shows a screenshot after the filtering operation of FIG. 2.

FIG. 4 shows how a set of multi-stream images is organized according to the invention.

FIG. 5 shows a rotation operation as an example of a mirrored operation on front and back side images according to the invention.

FIG. 6 shows processing steps for document identification and learning according to the invention.

FIG. 7 shows examples of embodiments of the invention for
document image indexing;
batch and document separation.

FIG. 8 shows examples of documents which can be processed according to the invention.

FIG. 9 shows a computer system for running the document separation and identification software.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

The invention firstly relates to methods for management of large amounts of images, in particular digitally acquired images by scanning or otherwise acquired, which are organized in sets or groups as in scanning and indexing software products. Such a software product according to the invention may for example be arranged for performing amongst others the following tasks:
connection to both to a high-speed scanner (e.g. up to 160 images per minutes) or to a low-end professional scanner (e.g. 30 images per minute);
scanning documents in color, black-and-white, grey scale or multi-stream, single side, or double side;
use of document recognition techniques such as for example on-line (during the scanning) barcode, OCR, patch code or intelligent to perform the following tasks:
   separation of a batch in several documents;
   indexing of batches and documents with the barcode value, the OCR value or the patch values;
displaying of the scanned images and of the indexes;
verification of the images quality;
verification of the document separation, correction of problems using tools such as split/merge, etc. . . . ;
verification tool to check the indexes and correct the indexes;
export of the batches, documents and indexes to other applications such as document management software or document recognition software.

In preferred embodiments, the invention enables to provide a true, native, multi-stream data structure for such a scanning and indexing software product. In particular, a true dual- of multi-stream data structure is presented in which the images relating to the same page or the same side of a page or the same scanning operation are grouped and subsequently can be handled together. To this end, the software product preferably comprises software code portions or algorithms arranged for enabling a user to perform given operations, such as for example cropping, resizing, or other, on all of the images belonging to the same group simultaneously. Preferably, the software product comprises software code portions or algorithms arranged for preventing a user from performing given operations on a single image of a group.

Preferably, the data structure used with the software product of the invention comprises the following hierarchy: a document comprises a number of pages that are composed of one front and one rear. The front may be composed of several images (1 to N) and the rear may be composed of several images (1 to N). It is the purpose of the invention to be able to manipulate the data at these different levels.

For instance, one can select one document as one specific object on which to apply a certain function (for instance delete the document, merge the document with another document, move the document from one place to the other, rotate all the pages in the document, apply the adjust image function to all pages of a document, etc. . . . )

For instance one can select a page which can be composed of a large number of images (single-stream/dual side: 2 images; dual-stream/dual side: 4 images, etc. . . . ) and apply specific operations on this page (delete the page, rotate the page, . . . )

In preferred embodiments of the invention, smart tools are implemented that are designed to work on an entire page in one operation (the page is composed of N images for the front and N images for the rear). These smart tools will perform differently on the front of the document and on the rear of the document and will affect at once all images of the page. Examples of such smart tools include:
Smart Rotation: if we rotate a page clockwise, the front will be rotate clockwise and the rear will be rotated counter clockwise;
Smart Crop: if we crop a zone on the upper right corner of the front, it will be cropped on the upper left corner on the back;
Smart Zoom: if we zoom a zone on the upper right corner of the front, it will be zoomed on the upper left corner on the bac.

In preferred embodiments of the invention, different modes are implemented to view and manipulate the information:
a document mode in which only a whole document can be used, modified, and accessed as a single entity;
a page mode in which only pages can be used, modified, and accessed as a single entity;
an image mode in which all the individual images can be accessed. This is similar to the existing image based products.

In preferred embodiments of the invention, security measures are implemented to provide the user with sufficient security with the various quality control operations that need to be performed on documents scanned in dual/multi-stream. For example in the page mode, such security measures may be implemented in operations as follows:
Secure Document Split: a split which can only happen between pages, so there is substantially no risk of removing one image inside of a dual-stream page;
Secure Document Merge: merge which cannot merge documents in an incorrect way.

In preferred embodiments of the invention, software code portions or algorithms are implemented which enable users to easily filter the different data and which can present different views to the user according to his needs. For instance, for a document which is composed of dual-stream/dual side pages, the following selection can be requested easily:
show all the front in color only;
show all the rear in black and white;
show the front in color and the rear in black-and-white

In preferred embodiments of the invention, the software code portions or algorithms are implemented such that the user is able to use the smart tools and the secure tools (split-and-merge) independently of the view which is selected. For instance, one can delete, rotate, crop, etc. all the images of a given page even when a view mode is selected which is showing only some of the images (e.g. color for the front and black-and-white for the rear).

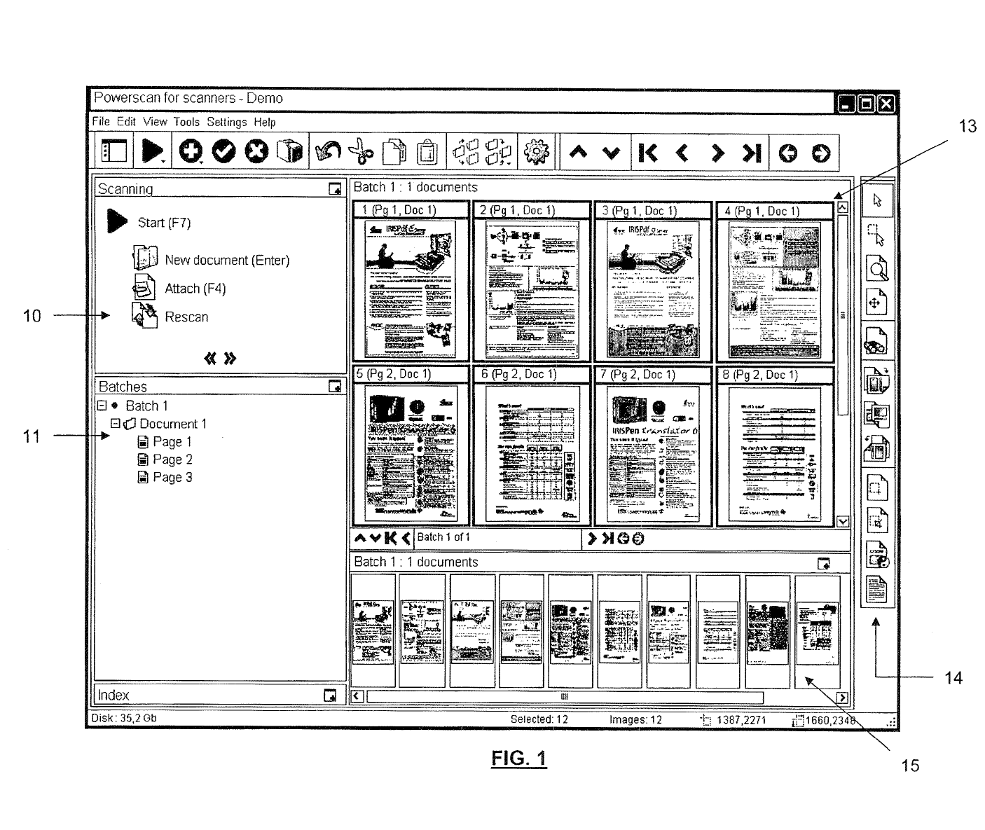

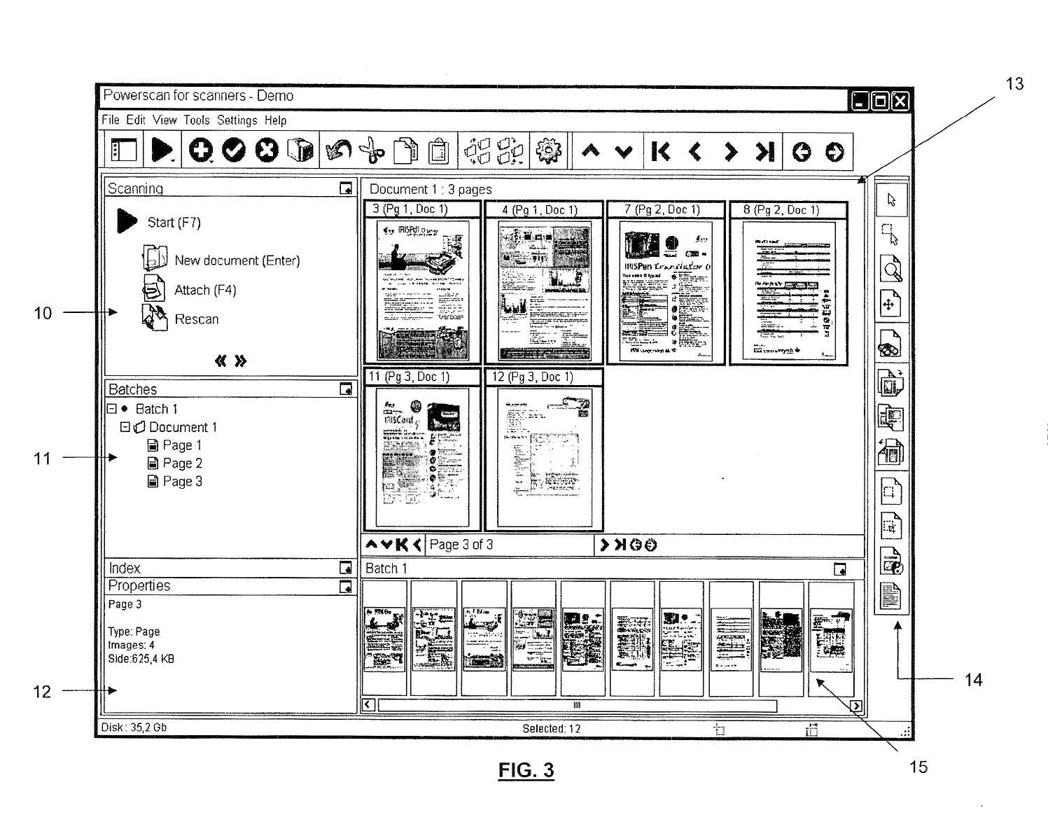

In FIGS. 1 and 3 it is shown how the running software product makes a batch of scanned documents visible towards a user and enables operations to be made. A first pane 10 shows a number of selectable scanning operations. A second pane 11 shows the hierarchy used according to the invention: batch—document—page. The page level corresponds to a group of images. This pane 11 could be adapted to include the image level. A third pane 12 can for example show the properties of the item which is selected in the second pane 11. A fourth pane 13 shows icons of the actual images. A fifth pane 16 gives a general overview of the document which is treated. This “document viewer” 16 is arranged for showing all the images belonging to the same document at once.

As is apparent from the fourth pane 13, in this case the scanned document “Document 1” is scanned in double sided, dual stream in black & white (=bitonal) and in color. Hence, icons 1 and 2 respectively represent the black & white scanned front side image and back side image of “Page 1”, icons 3 and 4 respectively represent the color scanned front side image and back side image of “Page 1”, icons 5 and 6 respectively represent the black & white scanned front side image and back side image of “Page 2”, icons 7 and 8 respectively represent the color scanned front side image and back side image of “Page 2”, and so on. Above the icon each time the page number and the document number are indicated between brackets.

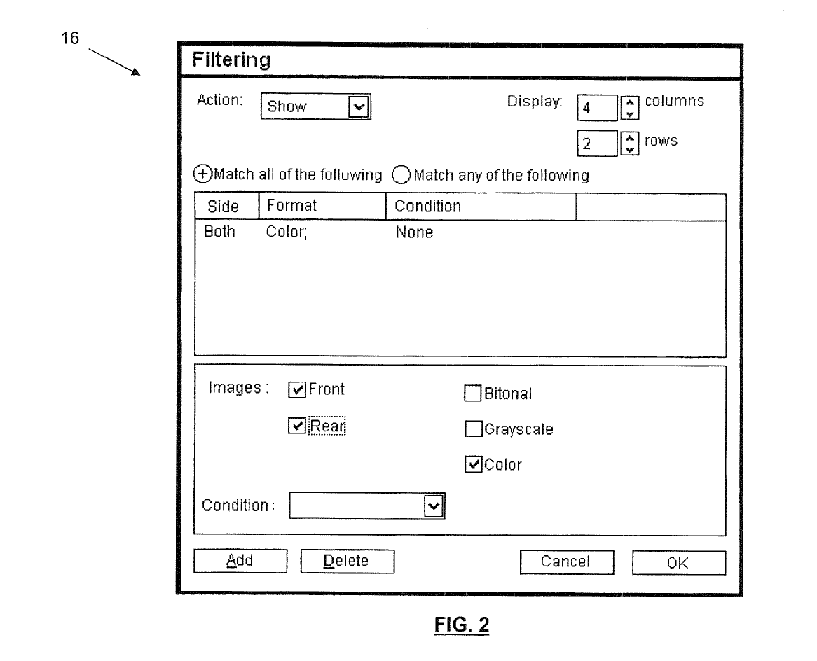

FIG. 2 shows a window 16 by which the images shown in the pane 13 can be specified in a filtering operation. FIG. 1 shows the situation before filtering: the pane 13 displays the eight images of two pages, which have been scanned double sided, in color and black & white. In the filter dialog window 16 settings are changed to set the filtering to display color images only.

FIG. 3 shows the filter result: pane 13 displays only the color images. Useful is that the document viewer pane 15 shows all images are still present in the data structure, i.e. no images are deleted, they are just no longer shown in pane 13.

On the right, a number of buttons 14 are shown which represent operations or smart tools as described above which can be jointly applied to all images of the same page at once, sometimes with the opposite effect on the front side image with respect to the back side image. For example, if “Page 1” would be selected the operation “rotate clockwise” would result in images 1 and 3 being rotated clockwise and images 2 and 4 being rotated counterclockwise. This only requires a single user operation, which shows the benefit of the data structure used according to the invention.

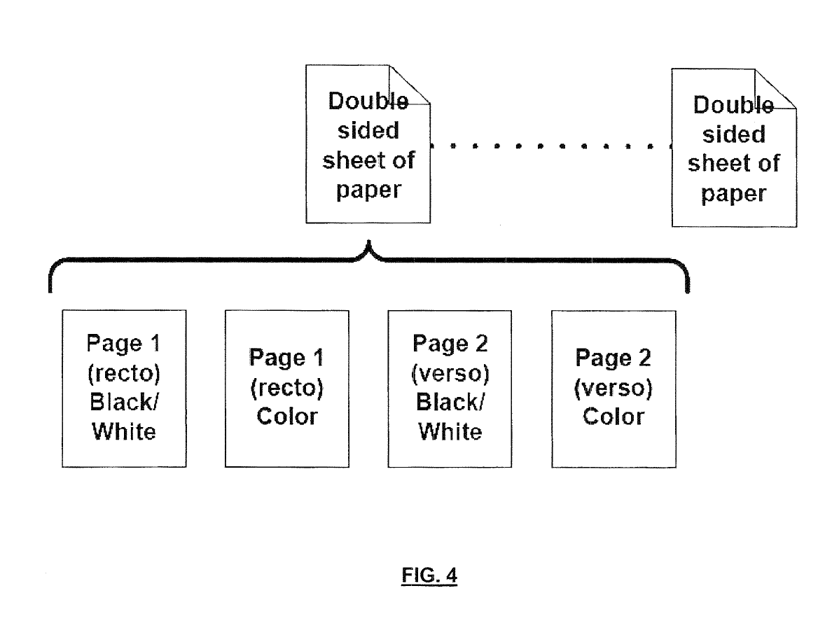

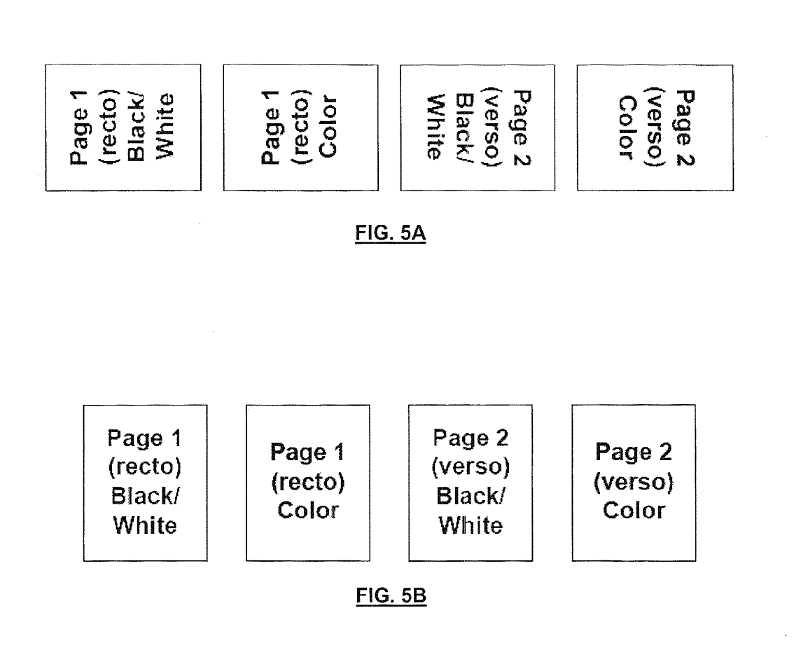

The above is further clarified by means of FIGS. 4 and 5.

FIG. 4 shows how the images are organized according to the invention. For each scanned double-sided sheet of paper multiple images are generated. In this case, the following set of different images is generated from the same original document: a black and white front side image and a color front side image (Page 1 recto), a black and white back side image and a color back side image (Page 2 verso). Possibly also a grayscale image of each side can be generated. All these images are bound in the set, and a series of predetermined operations on an image is transmitted to all the images of the set, such as for example Delete, Copy, Paste, Cut, Move, or other. Split & Merge operations in a batch are performed at the level of a set, not at image level, meaning that these operations are secured in such a way that a split can only occur between pages/sets and that a merge can only occur if the data structure is unaffected.

FIG. 5 shows how a page scanned in landscape, of which the recto side needs to be rotated clockwise and the verso side needs to be rotated counterclockwise, is treated. FIG. 5A shows the view before rotation. Selecting one of the images and rotating it transmits the operation to the other images of the set, such that the other image of the selected side is rotated in the same way and the images of the other side are rotated in the opposite way. So rotating the front side by 90° clockwise transmits the same rotation to all the images of the front side, and a rotation of 270° clockwise to all the images of the rear side. An advantage is that the scanning can now be performed on documents in landscape, which has a higher scanning speed, since the rotation of the pages afterwards is a simple operation which can even be automated.

Other examples of such mirrored operations are deskewing, cropping, flipping or other.

The invention further relates to document separation and identification software.

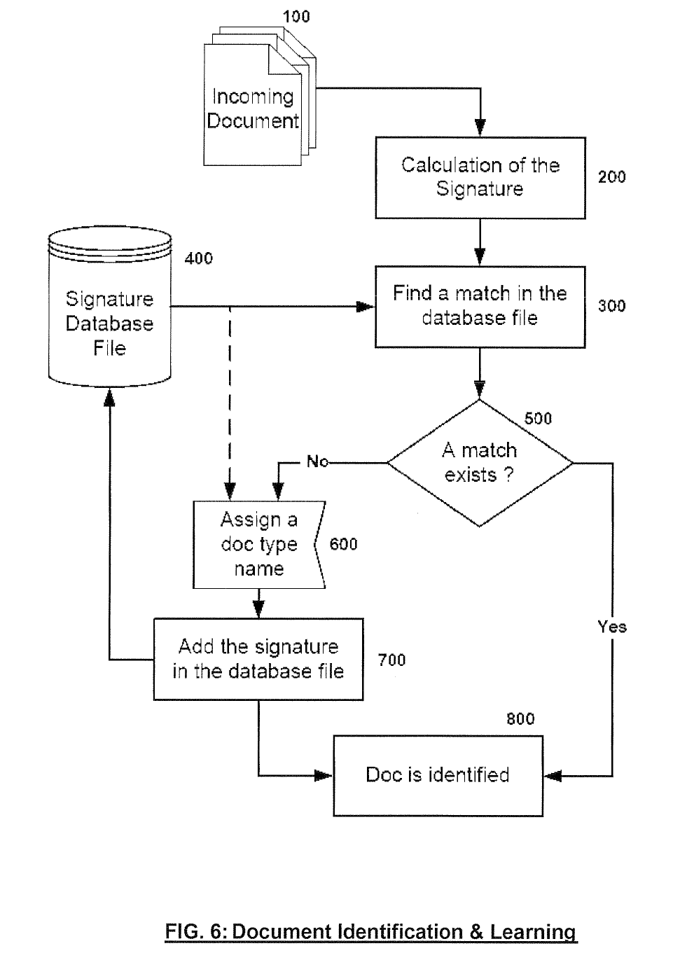

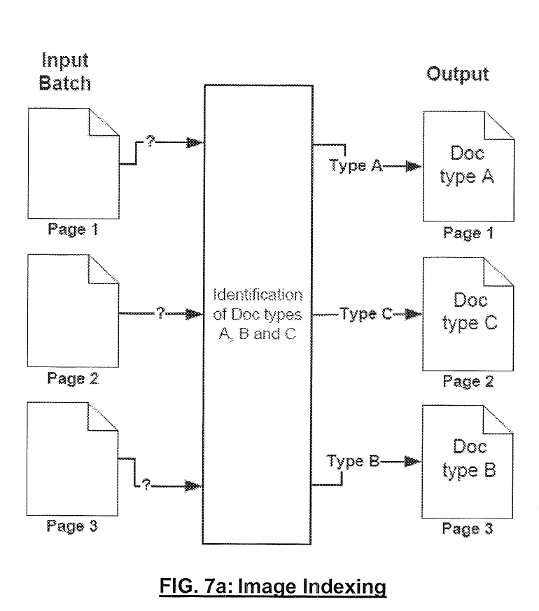

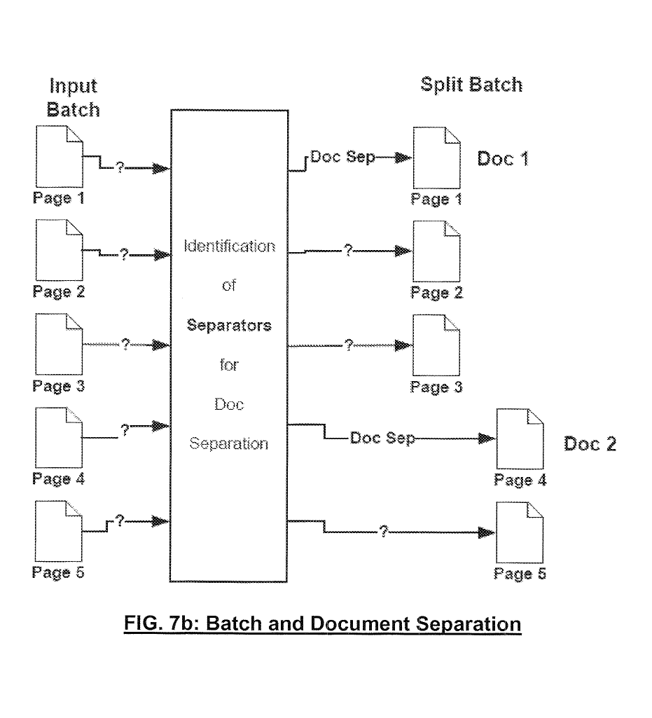

FIGS. 6-9 show a preferred embodiment of the invention, implementing a new separation and identification technique, based on a unique signature generated automatically for each page, without any interactive template definition, completion or adaptation.

This separation and identification technique is based on a very fast algorithm that analyzes the entire page, and generates a “signature” of that page. This signature is a mathematical transformation (modeling), based on a fast and robust image oriented algorithm, that is automatically calculated on all relevant elements present on the page and their relative position, including logos, lines of text, frames, lines, boxes, etc.

The signatures of all document types are collected in a database file. When a new document is processed, its signature is automatically calculated, and compared to all the signatures of the database file, for a matching. If there is no match, the signature can be added to the database file, with a newly assigned name.

This signature generation can avoid to perform OCR, allowing to reach a speed which is suitable for on-line separation and identification for high-speed scanners. Since no OCR is necessary, it allows:
to be language independent;
to identify documents without any OCR content;
to identify badly printed documents, like faxes.

Unlike barcode, patchcode and zoning OCR applications, this technique does not require any preparation of the documents before the scanning (for instance, stick a barcode on the first page of the document to ensure separation, or insert a separation sheet with an OCR zone or a patch code, before the beginning of a document, or defining regions of interest on the scanned images).

The configuration/training of the separation and identification process is performed in a very easy way. For an unknown document type, the image of that document is displayed, and the user has just to:
assign a name to that document type (maybe helped with a list of already known types);
specify the actions to perform on the batch of documents, when this document is encountered (batch or document separation, document renaming, etc).

The user interface may be implemented in many different ways, to present the list of already known documents to the user, to enter the new document type, to specify the document separation mode, etc. depending on the available GUI tools of the OS (drop-down lists, radio buttons, etc.).

When the configuration/learning is done, new batches can be scanned in and the document separation and identification of the type can be performed.

Further reference to the enclosed figures and associated text will give a clearer understanding of aspects of the invention.

FIG. 6 describes the different steps for the identification of documents, and the learning of unknown documents.

The incoming documents (100) are images coming from any source: scanners, fax servers, image servers, etc. They may be single page or multipage, and of any type: invoices, forms, orders, contracts, purchase orders, etc.

For every image of the document, a “signature” is calculated (200). This signature is a mathematical transformation (modeling), based on a fast image oriented algorithm, that is automatically calculated on all relevant elements present on the page and their relative position, including logos, lines of text, frames, lines, boxes, etc.

The calculated signature is used to find a match (300), by comparing it with a list of signatures contained in a database file (400) of already known documents. This comparison process generates a list of matches, with a confidence level for each of them.

For example, if there is only one matching in the list, it is accepted if the confidence level is greater than a minimum value, given as a configuration parameter.

If there are two matchings or more in the list, the system is able to decide if the match is valid or not, if the highest confidence level is greater than a minimum value given as a configuration parameter, and if the difference between the other confidence levels is greater than a minimum distance, given as a second configuration parameter.

These are examples of decision criteria, but other decision criteria may be implemented, based on the confidence levels, to be more flexible or stricter, for example, by accepting only one matching, etc.

If a match is valid, the document is identified (800).

If not, the image of the document is presented to an operator. The operator assigns a document type name (600) to the signature. This name can be either a new one, or one selected from the list of already known document types, for which signatures are stored in the signature database file. The system adds this signature in the signature database file (400), with the document type name. Several signatures may have the same document name.

The user interaction, and the training procedure are limited to the strict minimum: there is no template definition, no tuning, no definition of a specific region of interest to be OCR-ed. All he has to do is to assign a name to the unknown or unidentified document. This operation does not require a strongly trained user.

The method can even identify documents where some elements are missing, if enough information remains on the images.

The only constraints for a secure identification is to have enough characteristic graphical elements on them.

Online identification and separation may be used in different ways. FIG. 7 shows examples of embodiments according to the invention:
FIG. 7a: Image Indexing
   the identification is used to assign a name for each image of a document, or of a batch of documents;
   this name is then considered as an index of the image or of the document;
   in this example, the input batch consists of 3 pages of different types: type A, B and C;
   after the identification, page 1 is identified as a document of type A, page 2 as type C and page 3 as type B;
   this identification is an index attached to the image, defining for example the type of further processing to perform on each of them.
FIG. 7b: Batch and Document Separation
   the identification is used to detect some images that have to be considered as separators;
   these separators are used to split batches, documents or appendixes;
   only separators have to be known by the system (i.e. a signature for each type of separator is stored in the signature database file);
   in this example, the input batch consists of 5 pages of different types;
   after the identification, page 1 and page 4 are identified as document separator;
   the first document is composed of page 1, page 2 and page 3, while the second document is composed of page 4 and page 5;
   the batch can be split in documents, for further processing, like indexing and/or archiving.

In these two examples, the identification and the separation are performed online.

Other implementations may be realized, by mixing both examples here above. For example:
separation of a batch of scanned pages in documents;
detection of the appendixes;
indexing of the images of the documents, but not the images of the appendixes.

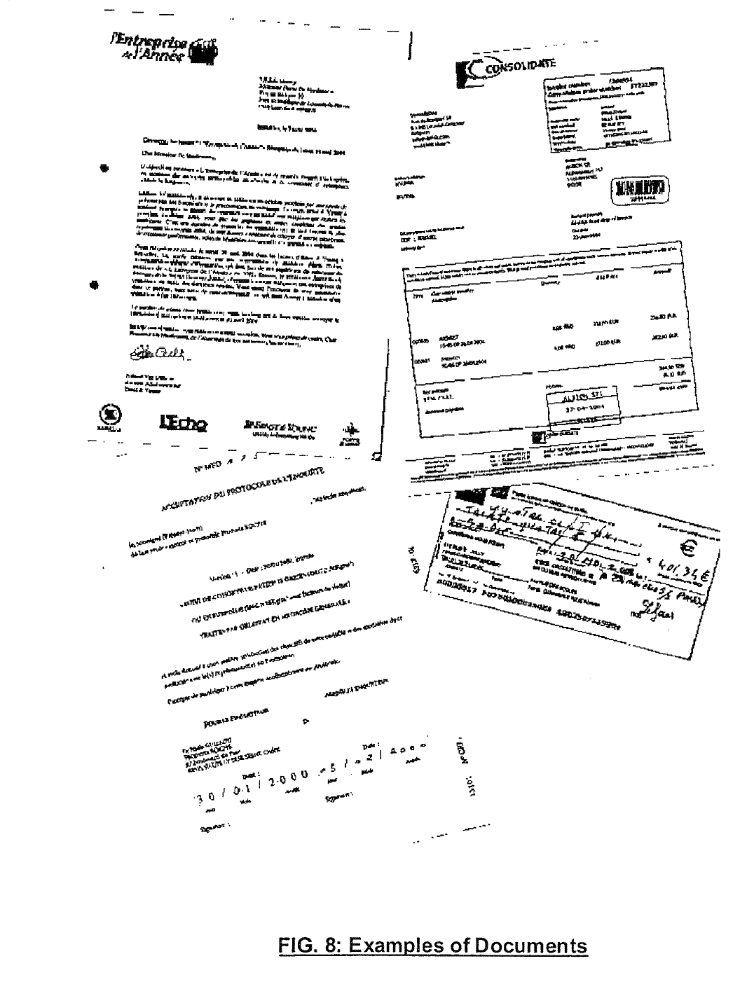

FIG. 8 shows examples of documents which can be processed according to the invention, namely:
a letter
an invoice
a CRF contract (Clinical Research Form)
a check

But this list is non-exhaustive, and the invention allows to identify and separate many types of documents, structured or unstructured, like forms (with or without lines/frames), invoices, letters, contracts, checks, purchase orders, etc.

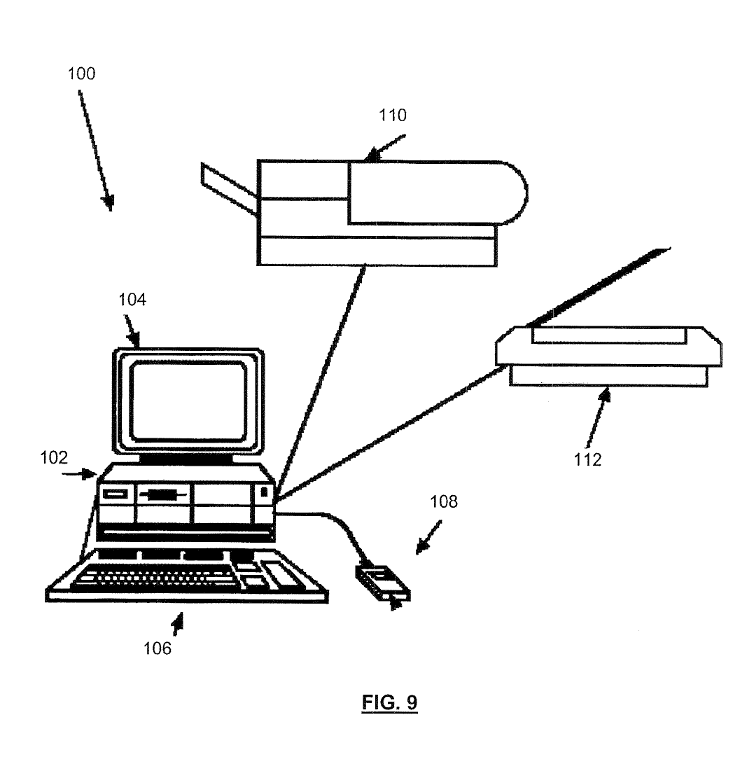

FIG. 9 illustrates a computer system upon which the methods according to the present invention can be implemented. The computer system 100 includes a processor 102, which has components (not shown) such as memories, a central processing unit, I/O controllers, and other components known to those skilled in the art. The processor 102 is connected to two input devices, a keyboard 106 and a mouse 108. Also connected is a scanner 112 for inputting the images to be processed and a printer 110 to output images and other documents.

1. A method for managing sets of digitally acquired images, the images of each set being acquired from the same original, characterised in that the method comprises the steps of handling said sets of images as units and restricting use of predetermined operations to all images of one or more of said sets only.

2. The method according to claim 1, wherein said sets of images are organised according to a hierarchy comprising a document level, a set level and a single image level, wherein a document is defined as a unit comprising a plurality of successive sets of images, wherein a first series of operations is restricted to use on document level, a second series of operations, comprising said predetermined operations, is restricted to use on set level and a third series of operations is restricted to use on image level.

3. The method according to claim 2, comprising the steps of implementing a plurality of modes enabling a user to view and manipulate said sets of images, one mode being implemented for each of said levels of said hierarchy.

4. The method according to any one of the previous claims, comprising the step of enabling a user to perform given image processing operations substantially simultaneously on all images of one or more of said sets.

5. The method according to any one of the previous claims, wherein each of said sets comprises at least one front side image representing a front side of said original and at least one back side image representing a back side of said original.

6. The method according to any one of the previous claims, wherein each of said sets contains multi-stream images which are substantially simultaneously acquired from said same original.

7. The method according to claim 6, further comprising the step of implementing security measures for avoiding operations that would distribute simultaneously acquired multi-stream images over different sets.

8. The method according to claim 7, wherein said security measures comprise a secure document split by which a document can only be split between said sets and a secure document merge by which documents can only be merged in such a way that said sets of images are maintained.

9. The method according to any one of the previous claims, further comprising the step of implementing filtering modes enabling a user to view only a same sub-set for each of said sets of images.

10. A method for managing sets of digitally acquired images, the images of each set being acquired from the same original, each set comprising at least one front side image representing a front side of said original and at least one back side image representing a back side of said original, characterised in that the method comprises the step of substantially simultaneously performing a first operation on the at least one front side image and a second operation on the at least one back side image, the second operation mirroring the first operation.

11. The method according to claim 10, wherein each of said sets contains at least two front side images and at least two back side images, said front and back side images respectively being multi-stream images which are substantially simultaneously acquired from said front side and said back side of said original.

12. The method according to claim 10 or 11, wherein said first and second operations are clockwise and counterclockwise rotations.

13. The method according to claim 10 or 11, wherein said first and second operations are cropping operations at opposite edges of said front and back side images.

14. The method according to claim 10 or 11, wherein said first and second operations are zooming operations on opposite zones of said front and back side images.

15. A computer program product directly loadable into a memory of a computer, comprising software code portions for performing the steps of the method of any one of the claims 1-14 when said product is run on a computer.

16. A computer program product according to claim 15, stored on a computer usable medium.

17. A method for separation and identification of digitally acquired documents, comprising the step of providing a digitally acquired image of an incoming document, characterized in that the method comprises the steps of:
(i) calculating a signature for said incoming document on the basis its image, and
(ii) correlating said signature with a database of signatures identifying document types.

18. The method of claim 17, characterized in that in step (i) said signature is calculated by applying a mathematical transformation on said image.

19. The method of claim 17 or 18, characterized in that in step (i) said signature is calculated on the basis of substantially the entire image.

20. The method of any one of the claims 17-19, characterized in that in step (i) said signature is calculated on the basis of relevant elements present in the image and their relative position.

21. The method of claim 20, characterized in that said relevant elements comprise graphical elements such as one or more of the following: logos, lines of text, frames, lines, boxes.

22. The method of any one of the claims 17-21, further comprising the following steps:
(iii) if said correlation reveals no match with any of said signatures in said database, assigning a new document type to said signature, and
(iv) adding said signature of said incoming document to said database.

23. The method of claim 22, characterized in that step (iii) comprises displaying the image the incoming document to a user and enabling the user to select a document type.

24. The method of claim 23, characterized in that said step of selecting a document type involves the possibility of selecting one of a list of already known document types.

25. The method of claim 23 or 24, characterized in that step (iii) further comprises the step of specifying actions to perform when said new document type is encountered in a batch of incoming documents.

26. The method of any one of the claims 17-25, characterized in that in step (ii) said correlation returns a number of matches with a confidence level for each match.

27. The method of claim 26, characterized in that in case only one match is returned, said match is accepted if the confidence level for the match is greater than a minimum value, given as a configuration parameter.

28. The method of claim 26, characterized in that in case at least two matches are returned, the match with the highest confidence level is accepted if the highest confidence level is above a minimum value, given as a first configuration parameter, and if the difference between the highest confidence level and the other confidence levels is greater than a minimum distance, given as a second configuration parameter.

29. The method of any one of the claims 17-28, further comprising the steps of attaching the identified document type as an index to the image, said index defining a further processing to be performed on the image.

30. The method of any one of the claims 17-29, further comprising the steps of:
(v) using said identification steps (i) and (ii) to first distinguish between document separators and appendixes in a batch of incoming documents,
(vi) splitting said batch at said separators,
(vii) maintaining only signatures for said separators in said database.

31. The method of any one of the claims 17-30, characterized in that the method is performed on-line.

32. A computer program product directly loadable into a memory of a computer, comprising software code portions for performing the steps of any one of the claims 17-31 when said product is run on a computer.

33. A computer program product according to claim 32, stored on a computer usable medium.
